(19) United States
(12) Patent Application Publication
(10) Pub. No.: US 2006/0180115 A1
(43) Pub. Date: Aug. 17, 2006

(54) Exhaust valve for internal combustion engine

(76) Inventor: Anthony T. Rubert, Rochester, NY (US)

Correspondence Address: Noreen L. Connolly, Esq.;Nixon Peabody LLP, Clinton Square, P.O. Box 31051, Rochester, NY, 14603-1051, US

(21) Appl. No.: 11/056,590

(22) Filed: Feb. 11, 2005

(51) Int. Cl. F02N 3/00

(52) U.S. Cl. 123/188.8; 123/188.2

(57) ABSTRACT

The present invention relates to an internal combustion engine exhaust valve having a valve head including a valve face and a valve back, wherein the valve face is convex, a cylindrical valve stem, and a rim that includes a valve seat; an exhaust valve assembly for an internal combustion engine that includes the exhaust valve of the present invention and an exhaust chamber; and an internal combustion engine including such an exhaust valve assembly. The present invention also relates to a method of increasing the efficiency of an internal combustion engine that involves providing an exhaust valve having a convex valve head and installing such an exhaust valve in an internal combustion engine, thereby increasing the efficiency of the engine.

### FIELD OF THE INVENTION

The present invention generally relates to an improved exhaust valve for an internal combustion engine having a valve head with a convex valve face, and methods of increasing the efficiency and power of an internal combustion engine by using the improved exhaust valve in an internal combustion engine.

### BACKGROUND OF THE INVENTION

An internal combustion engine includes one or more cylinders, each forming a combustion chamber for burning air/fuel mixtures to produce a mechanical energy. In an internal combustion engine of the piston and cylinder type, it is necessary to charge the cylinder with a fuel and air mixture during the combustion cycle and to vent or evacuate the exhaust gases during the exhaust cycle. During the induction stroke of the combustion cycle, the rotation of a cam shaft causes a spring-loaded valve, the intake valve, to open. This enables the fuel and air mixture to flow from the carburetor or fuel injector into the combustion chamber. During the compression and combustion stroke, the cam shaft closes the intake valve of the cylinder and the same cam shaft opens another spring-loaded valve, the exhaust valve. This allows the evacuation of exhaust gases from the cylinder after compression and combustion have occurred. These exhaust gases then exit the cylinder through an exhaust port and enter the exhaust manifold.

Exhaust valves are generally made of an elongated rod called the valve stem and an integrally connected disc-shaped surface called the valve head. The valve head is manufactured to have a seat that is adapted to mate with the internal edge surface of an orifice or port located usually in the top of the cylinder. The valve head and stem, even in the open position, constitute obstacles that may limit the flow of exhaust gases out of the combustion chamber or cylinder.

Current exhaust valve designs employ disc-shaped valve heads having relatively flat valve faces. While this shape is very efficient for intake valves, the use of flat valve heads are far from optimal for exhaust valves. This is because exhaust gases, when flowing over relatively flat valve heads, are expelled from the cylinder at less than optimal velocities. This, in turn, reduces the overall power obtainable by each combustion cycle, thus affecting the efficiency and speed of an internal combustion vehicle.

Basic to the efficient flow of gases over an object is the concept of laminar flow. Laminar flow is characterized by layers, or laminas, of air moving at the same velocity over an object. Laminar flow is affected by several factors, including the shape of the object over which the gas flows. Depending on the shape of an object, laminar flow may actually become turbulent flow, thus slowing the velocity of a gas over the object. This occurs because the concentric layers of flow may transfer energy from one layer to another, either accelerating or slowing the adjacent layer, which creates tumbling or turbulent flow around a specific object. This type of turbulent flow occurs to an extent when exhaust gases move out over, or past, flat exhaust valve heads, which reduces the overall efficiency of the combustion engine. Airflow in most engines is only about 80% efficient, which means that at normal running speeds, the cylinders are only ⅘^{th} full. The airflow efficiency of an engine is called the volumetric efficiency of an engine. Any increase in this efficiency affords greater power to the engine. There are several restrictions to airflow within an engine, however, maximizing the flow of exhaust gases over an exhaust valve has been largely overlooked. This lack of attention to improving the flow of exhaust gases over exhaust valves is paradoxical, because an increase in volumetric efficiency can equate with increases in engine performance. This effect would be even more pronounced in high performance vehicles, where even the slightest increase in engine performance could have significant effects on the outcome of a competition.

The efficient flow of gases through an engine is also affected by the amount of carbon buildup in an engine, including buildup on intake and exhaust valves. Gasoline, one of many fuels employed in internal combustion engines, is a mixture of hundreds of hydrocarbons. Upon the combustion of gasoline, carbon dioxide, carbon monoxide, water, and heat are the primary waste products. However, because the combustion process is not 100% efficient, intermediate hydrocarbons are also produced. These intermediate hydrocarbon waste products form the basis of carbon deposits and collect over time throughout the engine, including on the exhaust assembly. The buildup of carbon deposits on the valves, in particular the intake valve, causes incomplete sealing between the valves and the valve seats. When this occurs, small leaks between the exhaust valve and valve seat may result, allowing hot gases to escape and reducing the overall efficiency of an engine cycle. It is apparent that the efficient expulsion of exhaust gases would decrease the amount of potential carbon buildup in an engine, however, again there has been little to no attention paid to more efficient exhaust valve designs.

The present invention is directed to overcoming these and other deficiencies in the art.

### SUMMARY OF THE INVENTION

The present invention relates to an internal combustion engine exhaust valve having a valve head that includes a valve face and a valve back, where the valve face is convex, and a valve stem attached to the valve back. The valve of the present invention also includes a rim, which is an annular portion separating the valve face and valve head, the rim having a valve sealing surface. The attached valve stem preferably rises vertically from the center of the upper surface, or back, of the valve head, and may be integrally attached or attached by welding to the valve back. The valve stem includes an aspect near the distal end of the stem for engagement with a mechanical connector for moving the exhaust valve. In one embodiment of the present invention, this aspect is a lock groove. The valve is moved in a first direction and a second direction, (up and down or back and forth), and also is capable of being rotated. The valve head of the exhaust valve of the present invention, when viewed in cross-section, has a hemi-spherical shape, a hemi-spherical hollow shape, or a crescent shape.

Another embodiment of the present invention relates to an exhaust valve assembly for an internal combustion engine that includes the exhaust valve according to the first embodiment of the present invention and a combustion chamber to be used in concert with the exhaust valve. The combustion chamber includes an intake side and an exhaust side, where the exhaust side has an exhaust port. The exhaust valve of the present invention is placed on the exhaust side of the combustion chamber, positioned with the convex valve face directed towards the intake side of the combustion chamber and the valve back directed towards the exhaust port of the combustion chamber.

The present invention in another embodiment includes an internal combustion engine which employs an exhaust valve and exhaust chamber according to the present invention.

Another embodiment of the present invention is a method of making an efficient internal combustion engine. This method involves providing an exhaust valve according to the present invention and installing the valve in an internal combustion engine, thereby making an efficient internal combustion engine

The present invention provides an exhaust valve which, in contrast to known exhaust valves, has the advantage of a convex valve face. This design serves to improve the flow of hot exhaust gases from an internal combustion engine by providing a valve head surface more conducive to laminar flow, in contrast to currently employed flat disc-shaped exhaust valve heads. The improved expulsion of exhaust gases from an internal combustion engine affords numerous benefits including, without limitation, cleaner engines, more efficient engines, and engines capable of increased horsepower.

The present invention affords cleaner engines by improving the expulsion of exhaust gases containing carbon waste products produced from the inefficient burning of hydrocarbon fuels. Gasoline, a common internal combustion engine fuel, is a mixture of hundreds of hydrocarbons. Upon combustion, carbon dioxide, carbon monoxide, water, and heat are primarily produced. However, the process is not 100% efficient, thus, upon incomplete combustion numerous other waste products are produced. These waste products form the basis of carbon buildup in engines. Over time, carbon buildup can affect the proper function of an internal combustion engine by decreasing the effective volume of an engine's combustion chambers and by creating leaks within the combustion chamber due to buildup on the intake and exhaust valves and their respective valve seats. Carbon buildup also affects the proper function of an internal combustion engine by causing valve sticking which may result in valve burning, and by triggering pre-ignition events when loosened carbon deposits are ignited. By allowing the expulsion of exhaust gases to occur more smoothly, the gases also leave the combustion chamber more quickly, which in turn, allows for less buildup of carbon deposits within engines. Thus, another benefit of the exhaust valve of the present invention over prior art valves is a cleaner engine with a longer effective life span.

The present invention also provides a more efficient internal combustion engine. Efficiency is defined herein as the amount of fuel consumption per unit of power; the higher the efficiency the less fuel required to produce a unit of power. Not all internal combustion engines are designed to operate at maximum efficiency; however, any mechanism that improves the effective combustion process increases the efficiency of an internal combustion engine. The improved expulsion of gases, as accomplished by the present invention, improves the overall efficiency of combustion by allowing quicker fuel/air intake and less mixing of exhaust gases with the fuel and air combustion mixtures. In addition, the improved flow of the exhaust gases out of the combustion chamber due to improved laminar flow over the exhaust valve of the present invention provides the advantage of requiring less power to push the exhaust out of the cylinder, as the improved flow provides a scavenger effect to pull the hot gases from the combustion chamber.

The present invention also increases the potential horsepower obtainable from an internal combustion engine. Horsepower is a measure of how fast a certain amount of work can be done. Directly related to this value is torque, which is a measure of the actual amount of work that an engine can do, irrespective of how long it takes. Because of the direct relationship between torque and horsepower, a system which increases torque can increase horsepower. In an internal combustion engine, the peak torque value is achieved when the engine is inhaling the greatest amount of fuel and air into the combustion cylinder, which, when burned, makes the peak amount of cylinder pressure, and in turn, peak power. In order to achieve and maintain the maximum torque value, the waste gases must be expelled from the combustion chamber as efficiently as possible to allow the maximum charge of new fuel and air into the chamber. The present invention improves the expulsion of exhaust gases out of the combustion chamber allowing the torque peak to be increased and maintained, thereby increasing the horsepower of the engine.

The benefits of the present invention are most observable when employed with high performance vehicles. However, because the present invention provides a cleaner, more efficient, and more powerful engine, the exhaust valve of the present invention may be used with all internal combustion engines.

### BRIEF DESCRIPTION OF THE DRAWINGS

FIG. 1 shows a side view of a prior art exhaust valve.

FIGS. 2A-B show (A) a view from below valve head, and (B) a cross-section (side view) of the exhaust valve of present invention.

FIG. 3 shows the exhaust valve of present invention, in cross-section (side view).

### DETAILED DESCRIPTION OF DRAWINGS

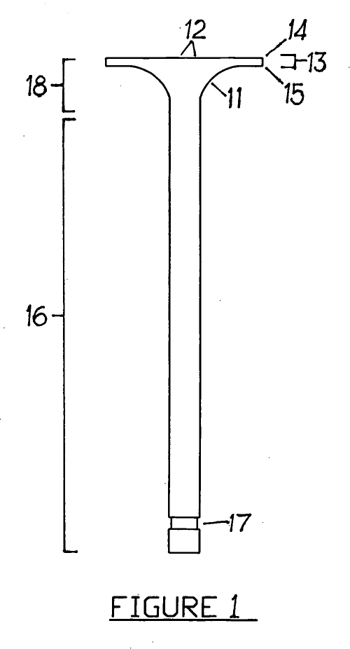

A commonly employed internal combustion exhaust valve is shown in FIG. 1. An exhaust valve is generally composed of a valve head 8 with an upper surface, the valve back 1, and a lower surface, the valve face 2. The valve back 1 and valve face 2 are separated by an annular rim portion 3. The rim often has a section with decreasing radius and a section with increased back angle which together make up the valve margin 4 and valve seat 5, respectively. The valve also contains a cylindrical valve stem 6 which rises axially from the upper surface of the valve head and which has an end remote to the valve back surface with a lock groove 7 for attachment to a spring retainer lock to allow the opening and closing, and rotation, of the exhaust valve in an internal combustion engine.

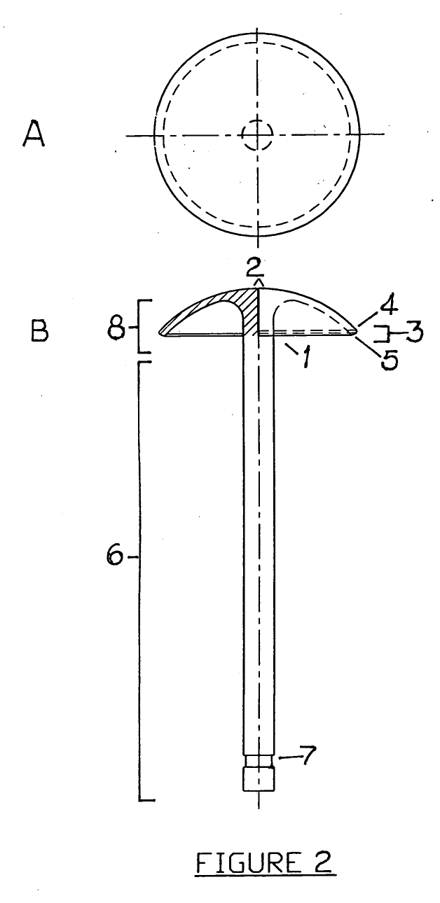

FIGS. 2A-B show one embodiment of the present invention. The valve head 18 is disc-shaped, i.e., having a circular perimeter, when viewed from below, as shown in FIG. 2A. The lower surface, i.e, valve face 12 of the valve head 18, has a convex shape, as seen in side view, FIG. 2B. By convex shape it is meant that in all embodiments of the present invention, the center of the face of the valve head will be higher than any resting outside edge. The valve head shape may include, without limitation, a hemi-spherical (solid or hollow) shape or a crescent-shape, when viewed from the side or in cross-section, as in FIG. 2B. The valve head 18 may be overall convexo-concave, wherein the valve face 12 is convex and the valve back 11 is concave. Alternatively, the valve head 18 may be convexo-convex, where both the face 12 and the back 11 are convex. Some convexity of the valve back 11 will further enhance the improved exhaust gas flow provided by the convex valve face 12, and the convex shape of the valve face 12 will overcome the added weight introduced by the convexity of the valve back 11. In some embodiments of the present invention, the convexity is larger or more pronounced than in others. The flow of gases over an object is related to the object's shape. A surface having a hemispherical shape produces a lower coefficient of drag than flow over a flat surface. The exhaust valve of the present invention makes use of this property to decrease the drag coefficient of exhaust gases as they flow over the exhaust valve during the exhaust stroke of the combustion cycle.

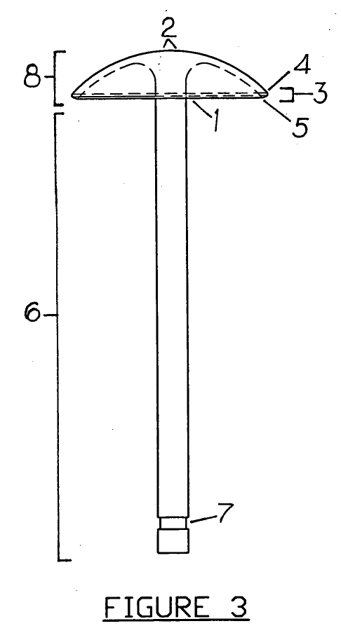

Specifically, the exhaust valve of the present invention is designed to have a convex valve face 12 which can range in shape from slightly crescent-shaped, defined as just barely curved over flat, to a full hemisphere, when viewed in cross-section, as shown in FIG. 3. In one embodiment, the valve back 11 is flat. In another embodiment the valve back contours upwards to the valve stem 16, having a solid hemispherical or solid crescent shape. In another embodiment, the valve back 11 recedes, or angles, down from the annular rim 13 to the valve stem 16, which rises axially from the valve face 12. The valve face 12 is made from a range of suitable materials including, preferably, stainless steel, titanium, a titanium alloy, an iron-nickel alloy, an iron-nickel-cobalt alloy, an aluminum alloy, a cast iron alloy, or a low alloy steel, depending on the application in which the exhaust valve is employed. The surfaces of the valve face 12 and valve back 11 may be mirror-smooth (i.e, highly-polished) or may be textured, such texture ranging from slightly- to highly-dimpled.

The exhaust valve of the present invention also includes a seating surface 15 of a thickness and width, respectively, to form a tight leak-free seal with the exhaust chamber port when in the closed position in an internal combustion engine. The valve seating surface 15 may have any thickness necessary to form a tight leak-free seal with the combustion chamber exhaust port. In one embodiment the exhaust valve of the present invention also has a margin 14, which, together with the valve seat 15, makes up the rim 13 of the valve head 18 and ensures a leak-proof seal during operation.

The valve head 18 also includes a cylindrical valve stem 16 which rises axially from preferably, the center of the valve back 11, and has an end distal to the valve back 11 with a connection to a mechanical member that allows the exhaust valve to be moved in a first direction and an opposing second direction, between an open and a closed position to control communication between a valve port and a cylinder. In addition, this mechanical connection allows for a rotational movement of the exhaust valve. In a preferred embodiment the valve stem 16 has a lock groove 17 that provides for attachment to a spring retainer lock to allow the valve to move from the open to the closed position rapidly and repeatedly, although other means may be used to provide attachment for movement of the exhaust valve within the combustion chamber. In a preferred embodiment of the present invention, the valve stem 16 is integrally attached to the valve back 11. As used herein “integrally attached” means that the valve back 11 and valve stem 16 are one piece, i.e, molded, machined, or otherwise made without need of connectors or welds to hold them together. In another embodiment, the valve stem 16 is welded to the valve back 11. The length and width dimensions of the exhaust valve are determined by the application of the valve. Factors determining the dimensions of the exhaust valve of the present invention include, without limitation, the materials from which the chamber is made; the shape, volume, length, and width of the combustion chamber; and the width and diameter of the combustion chamber exhaust port with which the exhaust valve seat forms a leak-proof interface with the exhaust chamber. The valve stem 16 may be made from a range of suitable materials including, preferably, stainless steel, titanium, a titanium alloy, an iron-nickel alloy, an iron-nickel-cobalt alloy, an aluminum alloy, a cast iron alloy, or a low alloy steel.

Another embodiment of the present invention is a combustion chamber that includes the exhaust valve of the of the present invention. The combustion chamber includes an intake side and an exhaust side, the intake side having an intake valve positioned therein, and the exhaust side having the exhaust valve of the present invention positioned therein. The exhaust side also includes an exhaust port for the expulsion of hot gases when the exhaust valve is in the open position in the combustion chamber. The combustion chamber of the present invention has the exhaust valve of the present invention positioned within the exhaust side of the combustion chamber with the convex valve face 12 directed towards the intake side of the combustion chamber and the valve back 11 and valve stem 16 directed towards the exhaust port. The valve seat 15 may be back angled to allow a leak-proof seal with the combustion chamber exhaust port when in the closed position. The combustion chamber is manufactured so as to seal with the valve seat 15 of the valve head 18 when the valve face 12 has a hemi-spherical, hemi-spherical hollow, or crescent shape. The combustion chamber may be made from a range of materials including, but not limited to, stainless steel, titanium, a titanium alloy, an iron-nickel alloy, an iron-nickel-cobalt alloy, an aluminum alloy, a cast iron alloy, or a low alloy steel.

The present invention includes a method of increasing the efficiency and horsepower of an internal combustion engine by providing the exhaust valve according to the first embodiment of the present invention and installing the valve in an internal combustion engine. The efficiency of an engine may be described in terms of the amount of fuel needed in order to produce a specific amount of power. Specifically, the higher the efficiency, the less fuel required to produce a unit of power. Among the factors that can affect the efficiency of an engine is the airflow within the engine which, in most cases, is only about 80% efficient. There are numerous restrictions to airflow within an engine including the air cleaner, throttle plates, bends in the manifold, intake valves, and exhaust valves. Each of these engine components slows the airflow into and out of the cylinder, all of which decrease the efficiency of an engine. The present invention provides an improved exhaust valve, as shown in FIGS. 2 and 3, which allows for the improved expulsion of exhaust gases from the combustion chamber. This is achieved by the novel design of the exhaust valve face 12 of the present invention, since a convex valve face will have much lower coefficient of drag than a flat-disc shaped valve face, allowing a smooth, laminar flow of exhaust gases past the exhaust valve and out of the combustion chamber. Because the present invention improves the movement of exhaust gases over the exhaust valve, the airflow out of the engine is increased and the overall efficiency of the engine can be maximized.

In addition, the exhaust valve of the present invention increases the effective horsepower of an internal combustion engine. Horsepower is directly related to engine torque which is related to the amount of airflow through an engine. When the volumetric efficiency of an engine is increased, torque is increased and, in turn, the horsepower of the engine increases. When the exhaust valve of the present invention is used in an internal combustion engine, the novel shape of the exhaust valve face 12 allows exhaust gases to flow more quickly out of the combustion chamber. This will allow more fuel and air to enter the chamber during the intake stroke of the combustion cycle, thus increasing the potential torque and subsequent horsepower. This improved flow of exhaust gases increases the volumetric efficiency of the engine, thus increasing the torque of the engine and, subsequently, horsepower.

The improved exhaust valve of the present invention is suitable for use in any vehicle powered by an internal combustion engine having one or more cylinders. For example, it may be installed in airplanes; automobiles, including, but not limited to, high performance automobiles; trucks; motorcycles; recreational vehicles including all terrain vehicles, motor boats, snow mobiles, jet skis, and wave runners; tractors, lawn mowers, and air compressors.

The foregoing description of the specific embodiments will so fully reveal the general nature of the present invention that others skilled in the art can, by applying current knowledge, readily modify or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of forms without departing from the invention.

What is claimed:

1. An internal combustion engine exhaust valve comprising:
a valve head comprising a valve face and a valve back, wherein the valve face is convex;
a valve stem attached to the valve back; and
a rim separating the valve face and valve head, wherein the rim comprises a valve sealing surface.

2. The exhaust valve according to claim 1, wherein the rim further comprises a margin.

3. The exhaust valve according to claim 1, wherein the valve stem is integrally attached to the valve head.

4. The exhaust valve according to claim 1, wherein the valve stem is welded to the valve head.

5. The exhaust valve according to claim 1, wherein the valve head viewed in cross-section has a hemi-spherical shape, a hemi-spherical hollow shape, or a crescent shape.

6. The exhaust valve according to claim 1, wherein the valve head viewed in cross-section has a hemi-spherical shape.

7. The exhaust valve according to claim 1, wherein valve head viewed in cross-section has a hemi-spherical hollow shape.

8. The exhaust valve according to claim 1, wherein the valve head viewed in cross-section has a crescent shape.

9. The exhaust valve according to claim 1, wherein the valve stem comprises a mechanical connection to a spring lock retainer for moving the exhaust valve.

10. The exhaust valve according to claim 9, wherein said moving is in a first direction and an opposing second direction, and a third direction, wherein the third direction is a rotational direction.

11. The exhaust valve according to claim 9, wherein the mechanical connection is a lock groove.

12. The exhaust valve according to claim 1, wherein the valve head comprises stainless steel, titanium, a titanium alloy, an iron-nickel alloy, an iron-nickel-cobalt alloy, an aluminum alloy, a cast iron alloy, or a low alloy steel.

13. The exhaust valve according to claim 1, wherein the valve stem comprises stainless steel, titanium, a titanium alloy, an iron-nickel alloy, an iron-nickel-cobalt alloy, an aluminum alloy, a cast iron alloy, or a low alloy steel.

14. An exhaust valve assembly for an internal combustion engine comprising:
a combustion chamber comprising an intake side and an exhaust side, wherein the exhaust side comprises an exhaust port, and
the exhaust valve according to claim 1, wherein the exhaust valve is placed on the exhaust side of the combustion chamber.

15. The exhaust valve assembly according to claim 14, wherein the valve head is positioned with the convex valve face directed towards the intake side of the combustion chamber and the valve back directed towards the exhaust port.

16. The exhaust valve assembly according to claim 14, wherein the valve seat is back angled to form a leak-proof interface with the exhaust chamber when the exhaust valve is in the closed position.

17. The exhaust valve assembly according to claim 14, wherein the valve head viewed in cross-section has a hemi-spherical shape, a hemi-spherical hollow shape, or a crescent shape.

18. The exhaust valve assembly according to claim 14, wherein the valve head comprises stainless steel, titanium, a titanium alloy, an iron-nickel alloy, an iron-nickel-cobalt alloy, an aluminum alloy, a cast iron alloy, or a low alloy steel.

19. The exhaust valve assembly according to claim 14, wherein the valve stem comprises stainless steel, titanium, a titanium alloy, an iron-nickel alloy, an iron-nickel-cobalt alloy, an aluminum alloy, a cast iron alloy, or a low alloy steel.

20. An internal combustion engine comprising the exhaust valve assembly according to claim 14.

21. The internal combustion engine according to claim 20, wherein the valve head viewed in cross-section has a hemi-spherical shape, a hemi-spherical hollow shape, or a crescent shape.

22. The internal combustion engine according to claim 20, wherein the valve head comprises stainless steel, titanium, a titanium alloy, an iron-nickel alloy, an iron-nickel-cobalt alloy, an aluminum alloy, a cast iron alloy, or a low alloy steel.

23. The internal combustion engine according to claim 20, wherein the valve stem comprises stainless steel, titanium, a titanium alloy, an iron-nickel alloy, an iron-nickel-cobalt alloy, an aluminum alloy, a cast iron alloy, or a low alloy steel.

24. A method of making an efficient internal combustion engine comprising:
providing at least one exhaust valve according to claim 1 and
installing said at least one exhaust valve in an internal combustion engine, thereby making an efficient internal combustion engine.

25. The method according to claim 24, wherein said installing occurs in vehicles selected from the group consisting of airplanes, automobiles, trucks, tractors, motorcycles, all terrain vehicles, motor boats, snow mobiles, jet skis, wave runners, lawn mowers, leaf blowers, and air compressors.
